(19) United States
(12) Patent Application Publication
(10) Pub. No.: US 2025/0273006 A1
(43) Pub. Date: Aug. 28, 2025

(54) SWITCHABLE AIR-REJECTING AND WATER-REJECTING OPTICAL FINGERPRINT SCANNING DEVICE

(71) Applicant: HID Global Corp., Austin, TX (US)

(72) Inventor: Daniel Henri Raguin, Jupiter, FL (US)

(21) Appl. No.: 18/857,208

(22) PCT Filed: Apr. 20, 2022
(86) PCT No.: PCT/US2022/071812

§ 371 Date: Oct. 16, 2024

(51) Int. Cl. G06V 40/13; G02B 7/18; G02B 13/00

(52) U.S. Cl. CPC G06V 40/1324; G02B 7/1805; G02B 13/0065

(57) ABSTRACT

A fingerprint scanning apparatus including a housing, prism mounting mechanics for fixing a prism within the housing to form a platen surface, wherein the mounting mechanics are configured to receive a prism geometry based on a first prism having a first index of refraction and a second prism having a second index of refraction, wherein the prism geometry comprises a critical angle with respect to the platen surface, wherein each of the first and second prisms has substantially the same critical angle with respect to a corresponding prism surface thereof, an objective lens, and an image sensor. In an example, the first prism has a critical index of refraction equal to or greater than an index of refraction of water and the second prism has a critical index of refraction equal to or greater than an index of refraction of air.

### TECHNICAL FIELD

The present disclosure relates to improved optical fingerprint sensing or scanning apparatuses, and particularly, improved optical fingerprint sensing or scanning apparatuses in a total internal reflection (TIR) configuration that allows for reduced or minimal mechanical, optical, and electrical changes when switching from an air-rejecting configuration to a water-rejecting configuration.

### BACKGROUND

Fingerprint sensing is widely used for identification or verification purposes. For this, a person's fingerprint is acquired by a fingerprint scanning apparatus whose output is processed and compared with stored characteristic data of one or more fingerprints to determine whether a match exists. Most fingerprint scanning apparatuses employ an optical imaging technique based upon total internal reflection (TIR).

Fingerprint scanners operating based upon TIR prisms are generally designed as either air-rejecting or water-rejecting. Conventionally, this has been done by designing and using two separate fingerprint scanners: one scanner being air-rejecting and one being water-rejecting. Generally, very few to no component parts of either scanner is shared between the two fingerprint scanner designs, resulting in no economies of scale in order quantities or inventory control.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a schematic diagram of an example TIR prism-based fingerprint scanner;

FIG. 2 illustrates a schematic diagram of a portion of a TIR prism-based fingerprint scanner;

FIG. 3 is a flow diagram for an example method for designing or selecting interchangeable prisms, such as a prism designed for an air-rejecting configuration and a prism designed for a water-rejecting configuration; and

FIG. 4 is a flow diagram for an example method for making a fingerprint scanning apparatus.

### DETAILED DESCRIPTION

The present disclosure generally relates to improved optical fingerprint sensing or scanning apparatuses, and particularly, improved optical fingerprint sensing or scanning apparatuses in a total internal reflection (TIR) configuration that allows for reduced or minimal mechanical, optical, and electrical changes when switching from an air-rejecting configuration to a water-rejecting configuration. One object of the various embodiments of the present disclosure is to provide a TIR contact optical fingerprint scanning apparatus that is capable of being quickly and simply interchanged between an air-rejecting and water-rejecting configuration, either at the manufacturing facility or in the field (e.g., at installation or in-situ).

In general, in various embodiment of the present disclosure, a switch between an air-rejecting and water-rejecting configuration is completed by changing the prism glass/material between low-index and high-index glasses/materials. Optionally, when switching between an air-rejecting and water-rejecting configuration, one or more additional changes or adjustments may be made, including but not limited to: removing a field lens, if present; adding a field lens; refocusing the objective lens; and changing or adjusting the Scheimpflug angle (discussed below). In an example, only the prism is changed. In another example, only the prism and the Scheimpflug angle are changed.

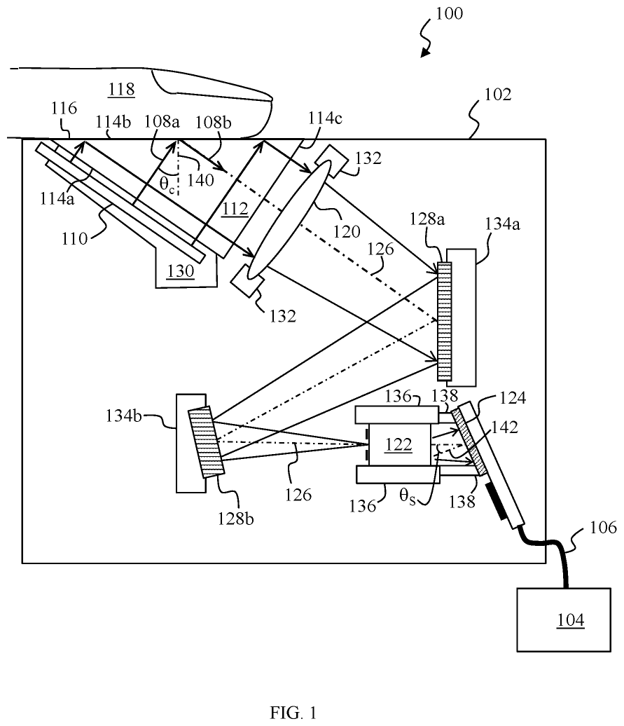

FIG. 1 schematically illustrates an example fingerprint scanning apparatus 100 contained within a housing 102 and connected to a processing device 104, such as a computer, microprocessor, or like device, via a communication and power cable 106. Within the housing 102, light 108a from an illumination source 110 is directed into a prism 112 via a first prism face 114a and onto a second prism face 114b which provides a surface or platen 116 upon which a person's finger(s) 118 is/are placed. Then, by TTR, light 108b reflected from the second prism face 114b passes through a third prism face 114c, may be redirected via an optional lens 120 (also referred to herein as a “field lens”), and is imaged by an objective lens 122 onto a two-dimensional (2D) sensor 124 (see, e.g., U.S. Pat. Nos. 2,195,699 and 5,416,573, each of which is hereby incorporated herein by reference in its entirety). For compactness, the optical path 126, along which the light 108b follows, may be “folded” via the use of one or mirrors (e.g., 128a and 128b) as illustrated schematically in FIG. 1. The illumination source 110 and prism 112 are mechanically fixed in place with mounting mechanics 130, the field lens 120 is mechanically fixed in place with mounting mechanics 132, and the mirrors 128a and 128b are mechanically fixed in place with mounting mechanics 134a and 134b, respectively. Also, the objective lens 122 is mechanically fixed in place with mounting mechanics 136, and the sensor 124 is mechanically fixed at a specific angle relative to the optical axis of the objective lens 122 with mounting mechanics 138. The sensor 124 is typically mounted such that the surface normal 142 of the sensor is not parallel to the optical axis of the optical path 126. This non-zero angle is a result of imaging a “tilted” object plane (namely, platen 116) and is referred to as the Scheimpflug angle θS.

According to Snell's Law, the internal critical angle θ_{c} with respect to the surface normal 140 of the second prism face 114b of the prism 112 is given by:

$${θ}_{c} = {sin}^{- 1} ( {n}_{c} / {n}_{p} ) , \qquad ( 1 )$$

where nₚ is the index of refraction of the prism (or prism material) 112 and n_{c}, referred to herein as the critical index of refraction or simply the critical index, is the largest desired index of refraction for a material touching the prism platen 116 wherein TIR still occurs.

Fingerprint scanners operating based upon TIR prisms are generally designed as either air-rejecting or water-rejecting. In general, for an air-rejecting configuration, for a material placed on the platen having an index of refraction greater than that of air (i.e., 1.00 at a light wavelength of 589 nm), the internal light striking the platen surface that normally is at TIR should be frustrated and leave the platen. For a water-rejecting configuration, for a material placed on the platen having an index of refraction greater than that of water (i.e., 1.333 at a light wavelength of 589 nm), the internal light striking the platen surface that normally is at TIR should be frustrated and leave the platen. For example, for an air-rejecting prism, n_{c} in Eq. (1) is set to a value ≥1.00 while for a water-rejecting prism, n_{c} is set to ≥1.333. In general, the higher the value of n_{c}, the larger the value of the critical angle θ_{c} and, therefore, the more “tilted” the platen 116 appears, and thus the more compressed in one axis the object touching the platen will appear, to the objective lens 122. As a result, the higher the critical index n_{c}, the higher the resolution that the optical system (e.g., the objective lens 122, the sensor 124, the optional field lens 120, and any mirrors 128a, 128b) should be and, therefore, the more expensive the optical system and/or objective lens 122 will likely be. Therefore, a water-rejecting fingerprint scanning apparatus is generally more expensive to fabricate than a comparable air-rejecting fingerprint scanning apparatus.

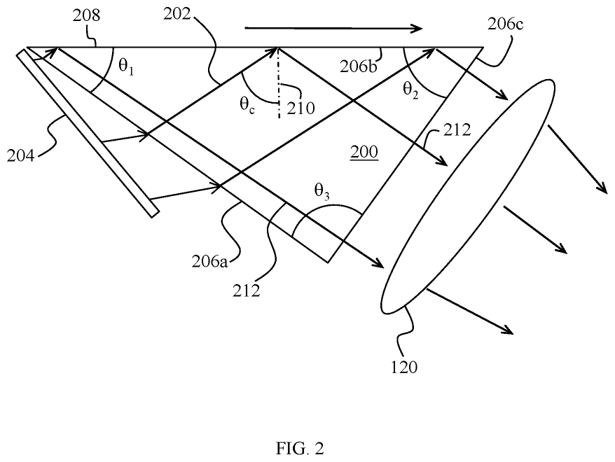

FIG. 2 schematically illustrates a TIR prism 200 similar to the prism 112 of FIG. 1 but having specific design parameters. Illumination light 202, from an illumination source 204, incident on the second prism face 206b (forming platen 208) forms a critical angle θ_{c} with respect to the surface normal 210 of the second prism face 206b. The prism 200 also has angles θ₁ (between the first prism face 206a and second prism face 206b), θ₂ (between the second prism face 206b and third prism face 206c), and θ₃ (between the first prism face 206a and third prism face 206c), and has an index of refraction, or is made from a material having an index of refraction, of nₚ. The prism 200 may be designed such that light 212 reflected from the second prism face 206b exits the third prism face 206c at or near normal incidence. In such examples, the angle θ₂ will be approximately equal to the critical angle θ_{c}. In some examples, in order to reduce or minimize the size of the prism 200, the first prism face 206a may be parallel or nearly parallel to the light rays 212 reflected from the second prism face 206b. In such examples, the angle θ₁ will be approximately equal to 90°-θ_{c}, and therefore the angle θ₃ may be approximately 90°.

While FIG. 2 schematically illustrates an example TIR prism 200 having a triangular cross-section, the various prisms of the present disclosure are not limited to prisms having only triangular cross-sections, and may include prisms having any suitable shape. Additionally, any surface of the prism, such as but not limited to the first prism face 206a or third prism face 206c, may be curved (e.g., convex or concave), textured, and/or include any other optical characteristic or effect applied thereto or embedded thereon. In an example, angles θ₁, θ₂, and θ₃ may simply be considered relative angles between the first 206a, second 206b, and third 206c prism faces, regardless of whether there are any additional prism faces or prism corners between these surfaces. For example, angle θ₁ may be the relative angle between the first prism face 206a (e.g., upon which an illumination source is applied) and the second prism face 206b (e.g., forming a platen surface), angle θ₂ may be the relative angle between the second prism face 206b and the third prism face 206c (e.g., through which light reflected from the second prism face exits), and angle θ₃ may be the relative angle between the first prism face 206a and the third prism face 206c. Those skilled in the art will understand and appreciate how the description herein for selecting interchangeable prisms (see below) applies to prisms of any suitable shape or cross-section.

The critical angle θ_{c} can be set according to the critical index n_{c} and the selected index of refraction of the prism nₚ (see Eq. (1)). In examples of the present disclosure, the same or substantially the same prism geometry (e.g., size and shape) can be used for both an air-rejecting prism and a water-rejecting prism for use in a single fingerprint scanning apparatus (e.g., apparatus 100), and therefore a single fingerprint scanning apparatus can be used for both an air-rejecting configuration and water-rejecting configuration by installing the appropriate corresponding prism or by switching between, or swapping, the air-rejecting prism and the water-rejecting prism. Because the air-rejecting prism and water-rejecting prism share the same or substantially the same geometry, no or substantially no change to the mounting mechanics (e.g., mechanics 130) of the fingerprint scanning apparatus (e.g., apparatus 100) required to hold the prism 200, when switching between air-rejecting and water-rejecting configurations, is needed. Instead, a switch or swap between an air-rejecting and water-rejecting configuration of the fingerprint scanning apparatus (e.g., apparatus 100) can be completed by installing the appropriate corresponding prism or by changing between the air-rejecting and water-rejecting prisms. Optionally, when switching between an air-rejecting and water-rejecting configuration, one or more additional changes or adjustments may be made, including but not limited to: removing the field lens, if present; adding the field lens; refocusing the objective lens; and changing or adjusting the Scheimpflug angle θ_{S}. In an example, only the prism is changed, or swapped out. In another example, only the prism and the Scheimpflug angle θ_{S} are changed.

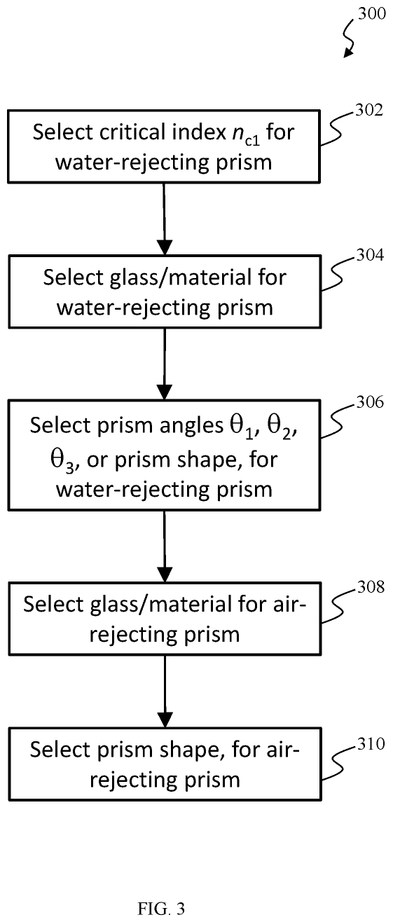

FIG. 3 illustrates an example method 300 for designing or selecting interchangeable prisms, such as a prism designed for an air-rejecting configuration and a prism designed for a water-rejecting configuration, having the same or substantially the same geometry such that the prisms may interchanged within a single fingerprint scanning apparatus (e.g., apparatus 100) with no or substantially no change to the prism mounting mechanics (e.g., mechanics 130) of the fingerprint scanning apparatus. In an example, having the same or substantially the same geometry may include the interchangeable prisms simply having the same or substantially the same critical angle θ_{c}. In an additional example, having the same or substantially the same geometry may include the interchangeable prisms having the same or substantially the same critical angle θ_{c} as well as having the same general prism shape. For example, in an embodiment, two interchangeable prisms may have the same or substantially the same critical angle θ_{c} as well as the same general prism shape, however, one or more edges of one of the interchangeable prisms may be longer or shorter than the respective edge of the other of the interchangeable prisms. In still another example, having the same or substantially the same geometry may include the interchangeable prisms having the same or substantially the same critical angle θ_{c} as well as having the same general prism size. For example, in an embodiment, two interchangeable prisms may have the same or substantially the same critical angle θ_{c} as well as the same general prism size, such that, for example, the prisms have a same or substantially same volume or such that the prisms each fit within a predefined or predetermined volume of space, however, the interchangeable prisms have different prism shapes. In an example, having a different prism shape may be relatively minimal, such as, for example, the third prism face 206c of one prism may be flat while the third prism face 206c of another prism may be curved. In other examples, having a different prism shape may be relatively extensive, such as, for example, one prism may be a triangular prism while another prism may be an irregular prism. In yet another example, having the same or substantially the same geometry may include the interchangeable prisms having the same or substantially the same critical angle θ_{c} as well as having the same general prism shape and same general prism size. In another example, having the same or substantially the same geometry may include the interchangeable prisms having the same or substantially the same critical angle θ_{c}, wherein the interchangeable prisms are each configured (e.g., sized and shaped) to mount within the same mounting mechanics 130 generally without, or with only limited, changes to a positioning of the mounting mechanics 130. Additionally, in an example, having the same or substantially the same geometry may include the interchangeable prisms having the same or substantially the same critical angle θ_{c}, wherein the interchangeable prisms are each configured (e.g., sized and shaped) to mount within mounting mechanics 130 generally without, or with only limited, changes to a positioning of the mounting mechanics 130 or illumination source 110. In still another example, the interchangeable prisms may have the same or substantially the same critical angle θ_{c} and be substantially identical in shape and size, providing for manufacturing and material tolerances.

As indicated above, in an example, each of the interchangeable prisms are designed or selected to have the same or substantially the same critical angle θ_{c}. That is, the critical angle θ_{c} remains substantially constant between the interchangeable prisms. However, each of the interchangeable prisms may be designed or selected to have a different index of refraction nₚ and different critical index n_{c}. Where the critical angle θ_{c} remains constant between two interchangeable prisms, the relationship between the index of refraction nₚ₁ and critical index n_{c1} of a first one of the prisms and the index of refraction nₚ₂ and critical index n_{c2} of the other prism based on Eq. (1) is:

$${θ}_{c} = {sin}^{- 1} ( {n}_{c 1} / {n}_{p 1} ) = {sin}^{- 1} ( {n}_{c 2} / {n}_{p 2} ) ,$$

which leads to

$${n}_{c 1} / {n}_{p 1} = {n}_{c 2} / {n}_{p 2} . \qquad ( 2 )$$

Based upon the foregoing, an initial step 302 of the method 300 involves selecting a critical index n_{c1} for a first one of the interchangeable prisms. Because prisms having higher critical indices are generally more expensive, the critical index for the interchangeable prism desired to have the higher critical index (as compared to the desired critical index of the other of the interchangeable prisms) may be selected first. In an example, the first one of the interchangeable prisms may be a water-rejecting prism. The index of refraction of pure water at a light wavelength of 589 nm is 1.333. Thus, for a water-rejecting prism, the critical index n_{c1} should be at least above 1.333. Selecting a critical index n_{c1} for a water-rejecting prism right at or substantially at the index of refraction of pure water (i.e., 1.333 at a light wavelength of 589 nm) should generally account for use cases where there is condensation on the fingerprint platen 116, as well as cases where the fingerprint scanning apparatus 100 might be wet from rainwater. However, selecting a critical index n_{c1} for a water-rejecting prism right at or substantially at the index of refraction of pure water (i.e., 1.333 at a light wavelength of 589 nm) would not typically account for the case of an individual with sweaty hands, where the salt content increases the index of refraction slightly above that of pure water. Selecting a critical index n_{c1} for a water-rejecting prism right at or substantially at the index of refraction of pure water (i.e., 1.333 at a light wavelength of 589 nm) would also not generally account for manufacturing tolerances or errors, such as but not limited to, mounting tolerances or errors for the prism, objective lens, or field lens, if present, or prism angle errors, that could potentially result in a lower achieved critical index of refraction. Similarly, one may want to account for the fact that the imaging optics have a certain numerical aperture (NA) and will image a cone of light rays from each field point on the platen 116 and, therefore, will image light rays across a range of platen angles. Accordingly, in order to compensate or account for the index of refraction of sweat, manufacturing tolerances or errors, and/or NA considerations of the imaging optics, in an example, a higher nominal critical index of refraction can be selected or designed for. For example, n_{c1} may be selected or designed to be substantially equal to or greater than 1.35 or other suitable nominal value greater than the index of refraction of pure water (i.e., 1.333 at a light wavelength of 589 nm).

Step 304 of the method 300 involves selecting a glass/material type for the first interchangeable prism based on the critical index n_{c1} selected at step 302. The glass/material type for the first interchangeable prism will define the index of refraction nₚ₁ for the first interchangeable prism. In an example, an optimal glass or material choice for a water-rejecting prism is one with a high or highest index of refraction nₚ since the higher the index of refraction, the smaller the critical angle θ_{c} will be according to Eq. (1). The smaller the critical angle θ_{c}, the less compressed the image at the platen 208 will be in a vertical or longitudinal axis or direction 214 (see FIG. 2), since the compression ratio for the vertical axis is equal to 1/cos θ_{c}. The compression ratio corresponds to how much lower the electronic resolution of the fingerprint scanning apparatus 100 will be in the vertical axis or direction 214 compared to a horizontal axis or direction that is perpendicular to the vertical axis or direction. Generally, the smaller the compression ratio, the lower the resolution that the objective lens 122 may be, and thus, the lower the cost the objective lens will tend to be. The compression ratio can also affect the sensor 124 selected or used for the fingerprint scanning apparatus 100, since the compression ratio corresponds to the desired rectangular ratio of the sensor, where the rectangular ratio is defined by the ratio of the number of pixels used in a horizontal direction across the sensor compared to the number of pixels used in a vertical direction across the sensor. For example, assuming no anamorphic corrective optics are used, such as additional prisms or cylindrical or toroidal lenses, then considering a platen area 208 to be imaged that is square and a compression ratio of 1.0 (meaning the platen does not appear “tilted” relative to the objective lens 122), then the sensor 124 may have a rectangular ratio of 1.0. However, if the compression ratio is, for example, 1.4 or 1.6, then the sensor 124 should desirably have a rectangular ratio of 1.4 or 1.6. In an example, for a fingerprint scanning apparatus 100 having a roughly square platen 208 and using spherical imaging optics (e.g., the objective lens 122 and the optional field lens 120), it can be advantageous to have a compression ratio of 1.5 or less. In view of the foregoing, there can be an advantage to having a high or relatively high index of refraction nₚ for the prism glass or material. However, generally, the higher the index of refraction nₚ of the glass or material, the more expensive such glass or material will likely be. Therefore, in general, the glass or material choice for the water-rejecting prism may be dictated by the highest material index of refraction suitable, considering the cost of the glass or material as well as the potential relative cost increase for the objective lens 122 if the compression ratio is too high.

Solely for the purpose of providing a non-limiting example of a process for selecting a glass/material for a water-rejecting prism, Table 1 illustrates some glass/material choices available from Schott AG (Mainz, Germany), along with their relative cost and indices of refraction at a light wavelength of 589 nm. Of course, glass/materials for any of the interchangeable prisms described herein are not limited to those identified in Table 1 nor to only glass/materials available from Schott AG. Rather, any suitable glass/material may be used for any of the interchangeable prisms described herein and may, for example, be alternatively or additionally obtained from any suitable glass/material supplier such, as but not limited to, CDGM Glass (China) and Ohara Corporation (Japan). Non-limiting example non-glass materials options for prisms can include plastics, monomers, and polymers such as acrylic, cyclic-olefin polymers (COPs), and cyclic-olefin copolymers (COCs). For example, for a water-rejecting prism, high-index plastics, such as those used for the lenses of eyeglasses, that can reach an index of refraction of greater than 1.7 may also be good options. For purposes of Table 1, the relative cost is in reference to the cost of the material N-BK7, which therefore has a relative cost of 1.0. The five glasses/materials with a prefix of “N-” means these glasses/materials meet RoHS (Restriction of Hazardous Substances directive), while the others do not. It is noted that for the RoHS and non-RoHS compliant glasses/materials, the higher the index of refraction, the higher the relative cost, with the exception of N-SF6. Since there is no index of refraction increase, and thus no critical angle benefit for selecting N-SF6, despite the increase in material cost, N-SF6 might not be a preferred material choice for a water-rejecting prism. Assuming the fingerprint scanning apparatus will be RoHS-compliant (and limiting to only the materials in Table 1), this leaves glass/materials N-SF15, N-SF10, N-SF11, and N-SF66 from which to choose. For the sake of further narrowing down the list of suitable glass/materials, in this example, it is assumed that acrylic is a highly likely material option for an air-rejecting prism due to its relatively low cost and because it can be generally easily injection-molded, cast, and/or machined to fabricate a prism. In view of the foregoing, considering a water-rejecting prism made from the glass/material N-SF66, due to its rather high index of refraction nₚ (i.e., 1.9229), and thus low minimum critical angle θ_{c} (i.e., 44.59°), a corresponding acrylic air-rejecting prism having the same prism geometry as the water-rejecting prism would have a critical index n_{c} that drops to 1.047. Since this is only slightly above the critical index of air (i.e., 1.00 at a light wavelength of 589 nm), glass/material N-SF66 might not be a preferred material for the water-rejecting prism. Moreover, it is noted that the cost of glass/material N-SF66 is nearly 50% more than glass/material N-SF11 and about double the cost of glass/materials N-SF15 and NSF10.

TABLE 1

| | | Index of | Min. | | | |
|---|---|---|---|---|---|---|
| | Relative | Refraction @ | Critical | Compression | n_{c} | n_{c} |
| Glass | Cost | 589 nm | Angle θ_{c} | ratio | w/Acrylic | w/N-BK7 |
| N-SF15 | 1.5 | 1.6989 | 52.62° | 1.65 | 1.185 | 1.205 |
| N-SF10 | 1.6 | 1.7283 | 51.36° | 1.60 | 1.165 | 1.185 |
| N-SF11 | 2.2 | 1.7847 | 49.15° | 1.53 | 1.128 | 1.148 |
| N-SF66 | 3.1 | 1.9229 | 44.59° | 1.40 | 1.047 | 1.065 |
| N-SF6 | 3.4 | 1.8052 | 48.40° | 1.51 | 1.116 | 1.134 |
| SF11 | 1.7 | 1.7847 | 49.15° | 1.53 | 1.128 | 1.148 |
| SF6 | 1.9 | 1.8052 | 48.40° | 1.51 | 1.116 | 1.134 |

Eliminating N-SF66 as a potential glass/material for the water-rejecting prism, the glass/materials N-SF15, N-SF10, and N-SF11 from Table 1 remain as potential candidates for this example. In an example, glass/material N-SF11 might be selected as a compromise between the index of refraction nₚ and cost, keeping in mind that a total cost for a prism is not dictated by the material cost alone, but also by the grinding and polishing required. As noted above, however, the foregoing process for selecting a glass/material for a water-rejecting prism is just a non-limiting example, and the glass/materials for any of the interchangeable prisms described herein are not limited to those identified in Table 1. Moreover, any number of additional or alternative factors may be considered when determining which glass/material might be desirable for any of the interchangeable prisms described herein, and the example factors used above in determining that the glass/material N-SF11 could be a suitable material for a water-rejecting prism are provided solely for the sake of illustrating a non-limiting example process for selecting a suitable prism glass or material.

Once the prism glass or material for the first interchangeable prism (e.g., the water-rejecting prism) is selected, step 306 of the method 300 involves selecting the prism angles θ₁, θ₂, θ₃, or otherwise the prism shape, for the first interchangeable prism. As indicated above, the prism 200 may be designed such that light 212 reflected from the second prism face 206b exits the third prism face 206c at or near normal incidence. In such examples, the angle θ₂ will be approximately equal to the critical angle θ_{c}. In an example, assuming the critical index n_{c1} selected in step 302 compensates or accounts for the index of refraction of sweat, manufacturing tolerances or errors, and/or NA considerations of the imaging optics, as described above, then in an example, the angle θ₂ can be designed to be at or substantially near the critical angle minimum requirement specified for the selected glass or material. In other examples, the angle θ₂ can be designed to be above the critical angle minimum requirement specified for the selected glass or material. However, increasing the angle θ₂ can generally put a greater burden on the imaging resolution or modulation transfer function (MTF) of the objective lens 122. The angles θ₁ and θ₃ may be selected or determined based on θ₂ and the desired prism geometry. In an example, for prism 200 compactness, the angle θ₁ may be designed to be equal to or approximately equal to 90°-θ₂ (e.g., 90°-θ_{c}) and the angle θ₃ may be designed to be equal to or approximately equal to 90°. As indicated above, the various prisms of the present disclosure are not limited to prisms having only triangular cross-sections and may include prisms having any suitable shape. Those skilled in the art will understand and appreciate how to design or select an appropriate prism shape for the first interchangeable prism based on the desired critical angle θ_{c}.

Step 308 of the method 300 involves selecting a glass/material type for the second interchangeable prism, thereby defining the index of refraction nₚ₂ and critical index n_{c2} for the second interchangeable prism. In an example, the second interchangeable prism may be an air-rejecting prism. In such an example, any suitable glass or material having an index of refraction nₚ allowing for a critical index n_{c} above the critical index of air (i.e., 1.00 at a light wavelength of 589 nm) and meeting the requirements of Eq. (2), above, may be used. However, a typical objective for an air-rejecting prism material is to reduce the cost of the system for cost-sensitive fingerprint scanning applications, since otherwise if a higher cost can be accepted, a water-rejection fingerprint scanner configuration would usually be selected as this allows for a wider range of fingerprint skin conditions to be scanned.

Solely for the purpose of providing a non-limiting example for a method for selecting a glass/material for an air-rejecting prism, as noted above, acrylic is a highly likely material option due to its relatively low cost and because it can be generally easily injection-molded, cast, and/or machined to fabricate a prism. Acrylic typically has an index of refraction nₚ of 1.49. In an example, assuming that glass/material N-SF11 was selected for the water-rejecting prism at step 304, Table 1 shows that a corresponding acrylic air-rejecting prism having the same geometry as the water-rejecting prism would have a critical index n_{c} of 1.128, which is safely above the index of refraction of air (i.e., 1.00 at a light wavelength of 589 nm). If, for example, plastic is not a desired prism material for the application, a relatively low-cost glass material, such as N-BK7 (with an index of refraction nₚ of 1.517) could alternatively be used. Assuming again that glass/material N-SF11 was selected for the water-rejecting prism at step 304, Table 1 shows that a corresponding air-rejecting prism made of N-BK-7 having the same geometry as the water-rejecting prism would have a critical index n_{c} of 1.148, which is also safely above the index of refraction of air (i.e., 1.00 at a light wavelength of 589 nm). Of course, as mentioned above, glass/materials for any of the interchangeable prisms described herein, including the air-rejecting prism, are not limited to those identified in Table 1 nor to only glass/materials available from Schott AG, and could be alternatively or additionally obtained from any suitable glass/material supplier such, as but not limited to, CDGM Glass (China) and Ohara Corporation (Japan). Non-limiting example non-glass materials options for prisms can include plastics, monomers, and polymers such as acrylic, cyclic-olefin polymers (COPs), and cyclic-olefin copolymers (COCs).

Step 310 of the method 300 involves selecting the prism geometry for the second interchangeable prism. In an example, the prism geometry for the second interchangeable is generally the same as for the first interchangeable prism, providing for manufacturing and material tolerances. In other examples, the second interchangeable prism may have substantially the same prism geometry as the first interchangeable prism. As explained above, in an example, having the same or substantially the same geometry may include the interchangeable prisms simply having the same or substantially the same critical angle θ_{c}. In an additional example, having the same or substantially the same geometry may include the interchangeable prisms having the same or substantially the same critical angle θ_{c} as well as having the same general prism shape. In still another example, having the same or substantially the same geometry may include the interchangeable prisms having the same or substantially the same critical angle θ_{c} as well as having the same general prism size. In yet another example, having the same or substantially the same geometry may include the interchangeable prisms having the same or substantially the same critical angle θ_{c} as well as having the same general prism shape and same general prism size. In another example, having the same or substantially the same geometry may include the interchangeable prisms having the same or substantially the same critical angle θ_{c}, wherein the interchangeable prisms are each configured (e.g., sized and shaped) to mount within the same mounting mechanics 130 generally without, or with only limited, changes to a positioning of the mounting mechanics 130. Additionally, in an example, having the same or substantially the same geometry may include the interchangeable prisms having the same or substantially the same critical angle θ_{c}, wherein the interchangeable prisms are each configured (e.g., sized and shaped) to mount within mounting mechanics 130 generally without, or with only limited, changes to a positioning of the mounting mechanics 130 or illumination source 110.

Although the flowchart of FIG. 3 illustrates an example method as comprising sequential steps or processes as having a particular order of operations, many of the steps or operations in the flowchart can be performed in parallel or concurrently, and the flowchart should be read in the context of the various embodiments of the present disclosure. The order of the method steps or process operations illustrated in FIG. 3 may be rearranged for some embodiments. Similarly, the method illustrated in FIG. 3 could have additional steps or operations not included therein or fewer steps or operations than those shown.

Moreover, while described above primarily with respect to air-rejecting and water-rejecting prisms, it is understood that prisms designed for any suitable critical indices n_{c} may follow the same method described above, and the method described above is not limited to designing prisms with critical indices specifically above the index of refraction of air and water. Additionally, while in the method described above, the water-rejecting prism (or the prism designed for the relatively higher critical index) was selected or designed before the air-rejecting prism (or the prism designed for the relatively lower critical index), it is understood that the selection or design of the interchangeable prisms could be reversed. That is, the air-rejecting prism (or the prism designed for the relatively lower critical index) could be selected or designed before the water-rejecting prism (or the prism designed for the relatively higher critical index). Also, while the method described above describes designing or selecting two interchangeable prisms having the same geometry, it is understood that the principles of the method described above could also be used to design or select more than two interchangeable prisms having the same geometry but having different indices of refraction nₚ and/or different critical indices n_{c}.

Having designed or selected the interchangeable prisms, such as a prism designed for an air-rejecting configuration and a prism designed for a water-rejecting configuration, having the same geometry, the fingerprint scanning apparatus 100 can be configured as or can be switchable between, for example, an air-rejecting fingerprint scanner and a water-rejecting fingerprint scanner by installing either the first or second interchangeable prism into the mounting mechanics 130. The mounting mechanics 130 may be configured for easy removal and installation of a prism. In an example, only the interchangeable prisms may need to be swapped in/out of the mounting mechanics 130 in order to switch the fingerprint scanning apparatus between, for example, an air-rejecting configuration and a water-rejecting configuration.

In an example, depending on the glass/material selected for the installed prism, the material of the installed prism may affect the optical path 126 of the fingerprint scanning apparatus. Thus, it may also be necessary or desirable to refocus the objective lens 122. Accordingly, in an example, the mounting mechanics 136 may be configured to permit translation and/or rotation of the objective lens 122 within the optical path 126.

In an example, depending on the glass/material selected for the installed prism, the index of refraction nₚ of the installed prism may affect the “tilt” of the platen perceived at the objective lens 122. Thus, it may also be necessary or desirable to adjust the Scheimpflug angle θ_{S} of the sensor 124. Accordingly, in an example, the mounting mechanics 138 may be configured to permit translation and/or rotation of the sensor 124 relative to the objective lens 122. In other examples, depending upon the MTF requirements for the fingerprint scanning apparatus 100, the fingerprint scanning apparatus may be configured such that the Scheimpflug angle θ_{S} is fixed or set at an angle (relative to the optical axis) that is between an ideal Scheimpflug angle for an air-rejecting configuration for the fingerprint scanning apparatus and an ideal Scheimpflug angle for a water-rejecting configuration for the fingerprint scanning apparatus that achieves an MTF that is sufficiently good for both configurations. In such an example, the mounting mechanics 138 need not be configured to permit translation and/or rotation of the sensor 124, as the angle of the sensor is configured at an angle that is sufficient for both the air-rejecting configuration (with the air-rejecting prism installed) and the water-rejecting configuration (with the water-rejecting prism installed) of the fingerprint scanning apparatus 100.

Solely for the purpose of providing a non-limiting example, a four-finger fingerprint scanner designed for 525-nm illumination and configured to accommodate a prism geometry of 40°-50°-90° (θ₁-θ₂-θ₃) was modeled using the software package OpticsStudio by Zemax LLC (Kirkland, WA). The fingerprint scanner was modeled with a BK7-glass prism used for an air-rejecting configuration and with an SF6-glass prism used for a water-rejecting configuration. The same objective lens and image sensor were used in the model for both configurations. In order to sustain approximately the same MTF performance while switching between the BK-7 and SF6 prisms, the objective lens used in the model was shifted (refocused) 14 microns and the sensor tilt (i.e., Scheimpflug angle θ_{S}) was changed between 3.20° (for the BK-7 prism) and 2.56° (for the SF6 prism). Accordingly, in a fingerprint scanning apparatus (e.g., 100) designed based on the foregoing model, depending upon the MTF requirements desired for the fingerprint scanning apparatus, in an example, the mounting mechanics 136 may be configured to permit at least a 14 micron translation of the objective lens 122 and the mounting mechanics 138 may be configured to permit tilting or rotation of the sensor 124 of up to or even more than 0.64° (i.e., the difference between 3.20° and 2.56°) relative to the objective lens 122. The permitted tilting of the sensor 124 may be a continuous adjustment such as with the use of spring mechanics with a screw adjustment but may also be achieved using any other suitable adjustment means, such as the use of a shim that can be inserted to provide the desired or required adjustment. In an example, depending upon the MTF desired for the fingerprint scanning apparatus, the mounting mechanics 138 may be configured to fix the sensor 124 at an angle between 3.20° and 2.56° relative to the objective lens 122, such as at an angle of 2.88° (i.e., the average of 3.20θ and 2.56°) relative to the objective lens. The foregoing example illustrates a case in which switching the scanner from an air-rejecting configuration using a BK7-glass prism to a water-rejecting configuration using a SF6-glass prism called for a shift or refocus of the objective lens by 14 microns, but in this example case, the two prisms were the same shape and size. As previously described, however, the various embodiments of the present disclosure are not so limited, and either the first or the second prism could additionally or alternatively be altered in size and/or shape while still fitting in the same mounting mechanics (e.g., mounting mechanics 130) such that no refocusing, or only limited refocusing, of the objective lens is desired or required when switching between the prisms.

As indicated above, the fingerprint scanning apparatus 100 may include an optional field lens 120. Such a field lens 120 is often utilized for a water-rejecting TIR fingerprint scanner. A purpose of the field lens 120 is to make the fingerprint scanning system telecentric in object space and, thereby, correct trapezoidal distortion that the “tilted” platen 116 would normally create. A field lens 120 is often not required for an air-rejecting TIR fingerprint scanner. Thus, for design (e.g., compactness, complexity, etc.) and cost-efficiency, a field lens 120 may excluded for an air-rejecting configuration of the fingerprint scanning apparatus 100. Accordingly, in an example, the mounting mechanics 132 may be configured for easy removal and installation of a field lens 120, as well as for adjustment thereof within the optical path 126.

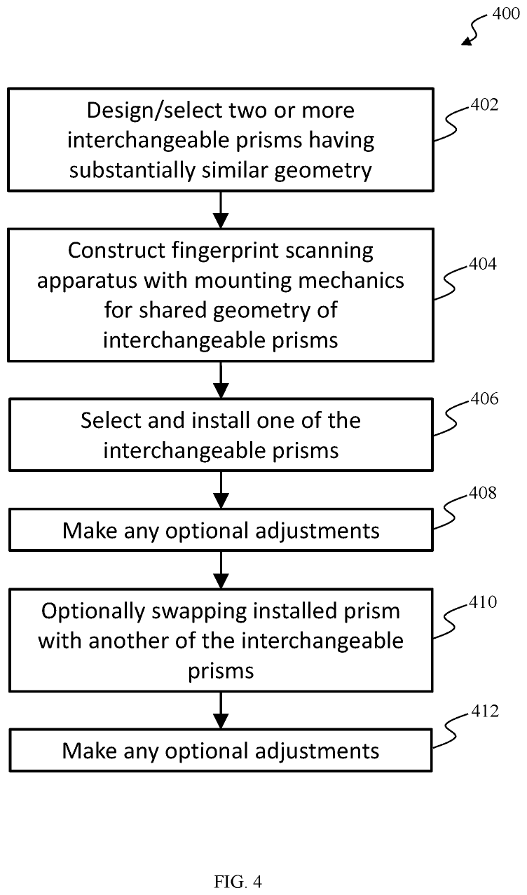

FIG. 4 illustrates an example method 400 for making a fingerprint scanner, such as fingerprint scanning apparatus 100, that enables a single fingerprint scanning apparatus to be configured as either an air-rejecting fingerprint scanner or a water-rejecting fingerprint scanner, with little modification to the fingerprint scanning apparatus. Step 402 of the method 400 involves designing or selecting two or more interchangeable prisms having the same or substantially the same geometry. In an example, step 402 involves the method 300 described above. In an example, a first one of the interchangeable prisms is designed or selected to be air-rejecting and a second one of the interchangeable prisms is designed or selected to be water-rejecting.

Step 404 of the method 400 involves constructing a fingerprint scanning apparatus, such as the fingerprint scanning apparatus 100, having mounting mechanics 130 configured for receiving a prism having the geometry shared by the interchangeable prisms resulting from step 402. The fingerprint scanning apparatus 100 is further constructed with an illumination source 110, objective lens 122, imaging sensor 124, any optional (field) lens 120 or mirrors (e.g., 128a, 128b) provided within the optical path 126 defined by the optical system of the fingerprint scanning apparatus, and any mounting mechanics (e.g., 132, 134a, 134b, 136, 138) for fixing the locations of the various components of the fingerprint scanning apparatus within a housing 102. In an example, the mounting mechanics 130 may be configured for easy removal and installation of any of the interchangeable prisms. In an example, the mounting mechanics 136 for the objective lens 122 may be configured to permit translation and/or rotation of the objective lens within the optical path 126 and/or the mounting mechanics 138 for the sensor 124 may be configured to permit translation and/or tilting or rotation of the sensor relative to the objective lens.

Step 406 of the method 400 involves selecting and installing one of the interchangeable prisms within the mounting mechanics 130. As indicated above, in an example, a first one of the interchangeable prisms is designed or selected for an air-rejecting configuration and a second one of the interchangeable prisms is designed or selected for a water-rejecting configuration. Accordingly, depending on whether it is desired that the fingerprint scanning apparatus 100 be air-rejecting or water-rejecting, the air-rejecting prism or water-rejecting prism, respectively, may be selected and installed. In an example, the fingerprint scanning apparatus 100 may be complete once the corresponding interchangeable prism is installed.

Step 408 of the method involves making any optional adjustments to the fingerprint scanning apparatus 100 based on the interchangeable prism installed and any effects on the optical system of the fingerprint scanning apparatus due thereto. For example, as indicated above, it may be necessary or desirable to refocus the objective lens 122 to account for effects on the optical path 126 resulting from the glass/material (or index of refraction nₚ) of the installed prism. As indicated above, the mounting mechanics 136 for the objective lens 122 may be configured to permit translation and/or rotation of the objective lens within the optical path 126, thereby permitting relatively easy adjustment or refocusing of the objective lens. As another example, as indicated above, it may be necessary or desirable to adjust the Scheimpflug angle θ_{S} of the sensor 124 to account for effects on the optical path 126 resulting from the glass/material (or index of refraction nₚ) of the installed prism. As indicated above, the mounting mechanics 138 for the sensor 124 may be configured to permit translation and/or tilting or rotation of the sensor relative to the objective lens 122, thereby permitting relatively easy adjustment of the sensor. In other examples, the mounting mechanics 138 for the sensor 124 need not be configured to permit translation and/or tilting or rotation of the sensor, and the angle of the sensor may be configured or fixed at an angle that is sufficient, depending on the MTF requirements for the fingerprint scanning apparatus, for all the interchangeable prisms (e.g., both an air-rejecting prism and a water-rejecting prism), as described above. As yet another example, any mounting mechanics 132 for an optional (field) lens 120 may be configured for easy removal and installation of a field lens, as well as for adjustment thereof within the optical path 126. In an example, the fingerprint scanning apparatus 100 may be complete once the corresponding interchangeable prism is installed and any optional adjustments are made.

At any time, subsequent step 406, a step 410 of the method 400 may optionally involve swapping the installed prism with another one of the interchangeable prisms. For example, if the fingerprint scanning apparatus 100 was configured for air-rejection, having an air-rejecting prism installed therein, and a manufacturer, user, or owner of the fingerprint scanning apparatus wants to reconfigure the fingerprint scanning apparatus for water-rejection, then the manufacturer, user, or owner can swap out the air-rejecting prism with the water-rejecting prism, which as described above, is designed to share the same or substantially the same geometry as the air-rejecting prism. Likewise, if the fingerprint scanning apparatus 100 was configured for water-rejection, having a water-rejecting prism installed therein, and a manufacturer, user, or owner of the fingerprint scanning apparatus wants to reconfigure the fingerprint scanning apparatus for air-rejection, then the manufacturer, user, or owner can swap out the water-rejecting prism with the air-rejecting prism, which is designed to share the same or substantially the same geometry as the water-rejecting prism. As noted above, the mounting mechanics 130 may be configured for easy removal and installation of the interchangeable prisms. In an example, only the interchangeable prisms may need to be swapped in/out of the mounting mechanics 130 in order to switch the fingerprint scanning apparatus between, for example, an air-rejecting configuration and a water-rejecting configuration.

Optional step 412 of the method involves making any optional adjustments to the fingerprint scanning apparatus 100 based on the interchangeable prism newly installed in step 410 and any effects on the optical system of the fingerprint scanning apparatus due thereto. These adjustments may include any of those previously described above with respect to step 408.

Although the flowchart of FIG. 4 illustrates an example method as comprising sequential steps or processes as having a particular order of operations, many of the steps or operations in the flowchart can be performed in parallel or concurrently, and the flowchart should be read in the context of the various embodiments of the present disclosure. The order of the method steps or process operations illustrated in FIG. 4 may be rearranged for some embodiments. Similarly, the method illustrated in FIG. 4 could have additional steps or operations not included therein or fewer steps or operations than those shown.

As will be appreciated, an advantage of the various embodiments of the present disclosure is that a single fingerprint scanning apparatus (e.g., 100) can be configured for or swapped between air-rejecting and water-rejecting configurations with, in some embodiments, installation of one of a plurality (e.g., two or more) of interchangeable prisms, such as the air-rejecting and water-rejecting prisms described above, that are designed with the same or substantially the same geometry and configured to interchangeably fit within the same mounting mechanics 130 of the fingerprint scanning apparatus 100. There may be no need to switch any mounting mechanics of the fingerprint scanning apparatus nor swap out the objective lens. Such a design leads to reduced development costs and reduced inventory costs, as the air-rejecting configurations and water-rejecting configurations share many components, in some cases generally all components except the prism and, optionally, the field lens, as opposed to being two entirely separate fingerprint scanner designs, as is conventionally done. Another advantage is a reduced consequence of miscalculated or under/over-estimated marketing and sales projections. For example, if sales forecasts inaccurately project water-rejecting scanners sales versus air-rejecting scanners sales, the consequence is not as severe with the various embodiments of the fingerprint scanning apparatus of the present disclosure due to its flexibility to switch between air-rejecting and water-rejecting configurations.

Again, while described above primarily with respect to air-rejecting and water-rejecting configurations, it is understood that prisms designed for any suitable critical indices n_{c} may be used, and the method described above is not limited to designing prisms specifically with critical indices relative to the index of refraction of air and water. In general, the present disclosure involves a single fingerprint scanning apparatus configured to be generally easily switchable between two or more scanning configurations based on two or more respective prism designs and/or glass/materials, with little modification to the fingerprint scanning apparatus.

### Additional Examples

Example 1 includes subject matter relating to a fingerprint scanning apparatus comprising: a housing; prism mounting mechanics for fixing a prism within the housing to form a platen surface, wherein the mounting mechanics are configured to receive a prism geometry based on a first prism having a first index of refraction and a second prism having a second index of refraction, wherein the prism geometry comprises a critical angle with respect to the platen surface, wherein each of the first and second prisms has substantially the same critical angle with respect to a corresponding prism surface thereof; an objective lens; and an image sensor.

In Example 2, the subject matter of Example 1 optionally includes wherein the first prism has a critical index of refraction equal to or greater than an index of refraction of water.

In Example 3, the subject matter of Example 1 or 2 optionally includes wherein the second prism has a critical index of refraction equal to or greater than an index of refraction of air.

In Example 4, the subject matter of any of Examples 1 to 3 optionally includes wherein the image sensor is fixed within the housing via sensor mounting mechanics, and wherein the sensor mounting mechanics are configured to permit at least one of translation or tilting/rotation of the sensor relative to the objective lens.

In Example 5, the subject matter of any of Examples 1 to 4 optionally includes wherein the objective lens is fixed within the housing via lens mounting mechanics, and wherein the lens mounting mechanics are configured to permit at least one of translation or rotation of the objective lens.

In Example 6, the subject matter of any of Examples 1 to 5 optionally includes field lens mounting mechanics configured for installation and removal of a field lens within the housing.

In Example 7, the subject matter of Example 6 optionally includes wherein the first prism is installed in the prism mounting mechanics, and further comprising a field lens installed in the field lens mounting mechanics and aligned within an optical path between the first prism and the objective lens.

In Example 8, the subject matter of any of Examples 1 to 7 optionally includes wherein the second prism comprises acrylic

In Example 9, the subject matter of any of Examples 1 to 6 or 8 optionally includes wherein the second prism is installed in the prism mounting mechanics.

Example 10 includes subject matter relating to a fingerprint scanning apparatus that is configurable between a water-rejecting scanner and an air-rejecting scanner, the fingerprint scanning apparatus comprising: a housing; prism mounting mechanics for fixing a prism within the housing to form a platen surface, wherein the mounting mechanics are configured to receive a prism geometry based on a first prism having a first index of refraction and a second prism having a second index of refraction, wherein the prism geometry comprises a critical angle with respect to the platen surface, wherein each of the first and second prisms has substantially the same critical angle with respect to a corresponding prism surface thereof; an objective lens fixed within the housing via lens mounting mechanics, wherein the lens mounting mechanics are configured to permit at least one of translation or tilting/rotation of the objective lens; and an image sensor fixed within the housing via sensor mounting mechanics, wherein the sensor mounting mechanics are configured to permit at least one of translation or rotation of the sensor relative to the objective lens.

In Example 11, the subject matter of Example 10 optionally includes wherein the first prism has a critical index of refraction equal to or greater than an index of refraction of water.

In Example 12, the subject matter of Example 11 or 12 optionally includes wherein the second prism has a critical index of refraction equal to or greater than an index of refraction of air.

Example 13 includes subject matter relating to a method for making a fingerprint scanning apparatus, the method comprising: designing a first prism and a second prism, wherein the first and second prisms have substantially the same prism geometry, and the first prism has a different index of refraction than the second prism; constructing prism mounting mechanics within a housing, the prism mounting mechanics configured to fix a prism having the prism geometry within a housing such that either the first prism or second prism can be interchangeably installed within the prism mounting mechanics; installing an objective lens within the housing via lens mounting mechanics; installing an image sensor within the housing via sensor mounting mechanics; and selecting one of the first or second prism, and installing the selected first or second prism within the prism mounting mechanics.

In Example 14, the subject matter of Example 13 optionally includes adjusting an angle of the image sensor relative to the objective lens.

In Example 15, the subject matter of Example 13 optionally includes wherein installing the image sensor within the housing via sensor mounting mechanics comprises installing the image sensor at a fixed Scheimpflug angle that is between an ideal Scheimpflug angle for the fingerprint scanning apparatus if the first prism was installed and an ideal Scheimpflug angle for the fingerprint scanning apparatus if the second prism was installed.

In Example 16, the subject matter of Example 13 optionally includes wherein installing the image sensor within the housing via sensor mounting mechanics comprises installing the image sensor at a fixed angle relative to the objective lens that sufficiently meets modular transfer function requirements for the fingerprint scanning apparatus when either the first prism or the second prism is installed in the prism mounting mechanics.

In Example 17, the subject matter of any of Examples 13 to 16 optionally includes adjusting at least one of a position or rotation of the objective lens.

In Example 18, the subject matter of any of Examples 13 to 17 optionally includes wherein designing the first prism and the second prism comprises: selecting a critical index of refraction for the first prism, wherein the critical index of refraction for the first prism is above an index of refraction for water; selecting a material for the first prism; selecting a geometry for the first prism; and selecting a material for the second prism based, at least in part, on the selected geometry of the first prism.

In Example 19, the subject matter of any of Examples 13 to 18 optionally includes removing the selected first or second prism from the prism mounting mechanics; and installing the other of the first or second prism within the prism mounting mechanics.

In Example 20, the subject matter of Example 19 optionally includes adjusting at least one of a position or angle of at least one of the objective lens or image sensor.

### ADDITIONAL NOTES

The above detailed description includes references to the accompanying drawings, which form a part of the detailed description. The drawings show, by way of illustration, specific embodiments that can be practiced. These embodiments may also be referred to herein as “examples.” Such embodiments or examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. That is, the above-described embodiments or examples or one or more aspects, features, or elements thereof can be used in combination with each other.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A fingerprint scanning apparatus comprising:
a housing;
prism mounting mechanics for fixing a prism within the housing to form a platen surface, wherein the mounting mechanics are configured to receive a prism geometry based on a first prism having a first index of refraction and a second prism having a second index of refraction, wherein the prism geometry comprises a critical angle with respect to the platen surface, wherein each of the first and second prisms has substantially the same critical angle with respect to a corresponding prism surface thereof;
an objective lens; and
an image sensor.

2. The fingerprint scanning apparatus of claim 1, wherein the first prism has a critical index of refraction equal to or greater than an index of refraction of water.

3. The fingerprint scanning apparatus of claim 1, wherein the second prism has a critical index of refraction equal to or greater than an index of refraction of air.

4. The fingerprint scanning apparatus of claim 1, wherein the image sensor is fixed within the housing via sensor mounting mechanics, and wherein the sensor mounting mechanics are configured to permit at least one of translation or tilting of the sensor relative to the objective lens.

5. The fingerprint scanning apparatus of claim 1, wherein the objective lens is fixed within the housing via lens mounting mechanics, and wherein the lens mounting mechanics are configured to permit at least one of translation or rotation of the objective lens.

6. The fingerprint scanning apparatus of claim 1, further comprising field lens mounting mechanics configured for installation and removal of a field lens within the housing.

7. The fingerprint scanning apparatus of claim 6, wherein the first prism is installed in the prism mounting mechanics, and further comprising a field lens installed in the field lens mounting mechanics and aligned within an optical path between the first prism and the objective lens.

8. The fingerprint scanning apparatus of claim 1, wherein the second prism comprises acrylic.

9. The fingerprint scanning apparatus of claim 1, wherein the second prism is installed in the prism mounting mechanics.

10. A method for making a fingerprint scanning apparatus, the method comprising:
designing a first prism and a second prism, wherein the first and second prisms have substantially the same prism geometry, and the first prism has a different index of refraction than the second prism;
constructing prism mounting mechanics within a housing, the prism mounting mechanics configured to fix a prism having the prism geometry within a housing such that either the first prism or second prism can be interchangeably installed within the prism mounting mechanics;
installing an objective lens within the housing via lens mounting mechanics;
installing an image sensor within the housing via sensor mounting mechanics; and
selecting one of the first or second prism, and installing the selected first or second prism within the prism mounting mechanics.

11. The method of claim 10, further comprising adjusting an angle of the image sensor relative to the objective lens.

12. The method of claim 10, wherein installing the image sensor within the housing via sensor mounting mechanics comprises installing the image sensor at a fixed Scheimpflug angle that is between an ideal Scheimpflug angle for the fingerprint scanning apparatus if the first prism was installed and an ideal Scheimpflug angle for the fingerprint scanning apparatus if the second prism was installed.

13. The method of claim 10, wherein installing the image sensor within the housing via sensor mounting mechanics comprises installing the image sensor at a fixed angle relative to the objective lens that sufficiently meets modular transfer function requirements for the fingerprint scanning apparatus when either the first prism or the second prism is installed in the prism mounting mechanics.

14. The method of claim 10, further comprising adjusting at least one of a position or rotation of the objective lens.

15. The method of claim 10, wherein designing the first prism and the second prism comprises:
selecting a critical index of refraction for the first prism, wherein the critical index of refraction for the first prism is above an index of refraction for water;
selecting a material for the first prism;
selecting a geometry for the first prism; and
selecting a material for the second prism based, at least in part, on the selected geometry of the first prism.

16. The method of claim 10, further comprising:
removing the selected first or second prism from the prism mounting mechanics; and
installing the other of the first or second prism within the prism mounting mechanics.

17. The method of claim 16, further comprising adjusting at least one of a position or angle of at least one of the objective lens or image sensor.
